(19) United States
(12) Patent Application Publication
(10) Pub. No.: US 2009/0204456 A1
(43) Pub. Date: Aug. 13, 2009

(54) Methods for identifying areas for business change and prioritization based upon impact using diagrammatic representations of business systems

(76) Inventor: Mark Rubin, Gaithersburg, MD (US)

Correspondence Address: TRIANGLE PATENTS, P.L.L.C., P.O. BOX 28539, RALEIGH, NC, 27611-8539, US

(21) Appl. No.: 12/322,300

(22) Filed: Jan. 30, 2009

Related U.S. Application Data
(60) Provisional application No. 61/063,039, filed on Jan. 31, 2008.

(51) Int. Cl. G06Q 10/00

(52) U.S. Cl. 705/7

(57) ABSTRACT

Systems and methods for providing an automated system for identifying areas of a business for implementing changes in processes, human resources, metrics, and systems, wherein the identification is provided based upon generating a visual representation of a business based on the energy and information systems of the business, and by making those changes to improve the operating efficiency of the business.

### CROSS-REFERENCE TO RELATED APPLICATIONS

The present application is claims the priority filing benefit from U.S. Provisional Patent Application Ser. No. 61/063,039 filed Jan. 31, 2008, which is incorporated herein by reference in its entirety.

### BACKGROUND OF THE INVENTION

1. Field of the Invention

The present invention relates generally to systems modeling, and more particularly, to business, information, and energy systems modeling.

2. Description of the Prior Art

Generally, it is known in the art to provide methods for visualizing business data, organizations, or relationships within a business. In one case, U.S. Pat. No. 2,393,162 issued Jan. 15, 1946 to Hayes for Business Method Analyzer, FIG. 1 illustrates a mechanical device with weights applied to pins vertically oriented as discrete silos representing expenses and departments within a business that move the device in a vertical direction only to show an increase or decrease in some financial amount. Other publications in the prior art include:

US Patent Application Publication No. 20080120573 for Business process diagram visualization using heat maps wherein the diagram includes a plurality of icons connected by lines, such as a flow diagram of the business process, wherein the graphical indications may indicate lengths of time, costs, or other characteristics associated with the various steps within the business process flow diagram.

US Patent Application Publication No. 20060112123 for Spreadsheet user-interfaced business data visualization and publishing system discloses a spreadsheet user-interfaced web-based business data publishing system that allows users to input and visualize field data and analytical results with interactive charts (like Microsoft Excel spreadsheet), wherein charts are customized and business dashboards are constructed through a drag-n-drop process.

US Patent Application Publication No. 20050086092 for Methods and systems for diagramming and remotely manipulating business objects teaches a computer-implemented method of representing and manipulating a diagram that includes a representation of a plurality of interconnected business objects on a browser including steps of displaying at least a portion of the diagram in an active area of the browser, further including a diagram overview with hierarchical information regarding the business objects.

U.S. Pat. No. 6,995,768 for Interactive business data visualization system describes an interactive system for visualizing business data organized according to the dimensional model that allows for the combination of data from more than one data source and presents the data in a graphical, multi-metric data visualization format, wherein the data is hierarchically structured and built from visualization elements including, in ascending order of hierarchy, charts, panels, scenes and sheets, and includes 2-dimensional and 3-dimensional visualization elements as well as animation effect.

U.S. Pat. No. 6,604,114 for Systems and methods for organizing data describing a software system processing a user query for information that organizes, analyzes and presents relevant data for the user in a graphical manner, for supporting decision-making and for presenting data relationships across multiple planes and accessing dissimilar data sets; also includes the ability to show underlying data from the data sets.

However, none of the prior art provides systems and methods for modeling a business based upon visual representation of the energy and information systems, in addition to human resources and their relationships to the energy and information systems that comprise a given business, such that the business itself may be understood based upon that visual representation. Even in this modern era of computer technology, databases, spreadsheets, and graphic user interfaces there is not any software that provides a complete visual representation of a business based upon the energy and information systems that comprise the business itself, i.e., to provide a complete picture of the overall business and its various component activities, inputs, and outputs for representing the efficiency of the business throughout any part of it, as well as the overall efficiency (or profitability) of the business itself. Thus, there remains a longstanding and unmet need to provide systems and methods for providing visual representation of the energy and information systems, in addition to people and that provide a scale and perspective on those systems and people such that the business systems can be understood, and then business decisions and actions can be made to make changes in any part of the systems for creating positive impact, i.e., to increase the profitability of the system therefrom, and then to produce a new visualization of the improved system to illustrate that positive impact.

### SUMMARY OF THE INVENTION

The present invention provides systems and methods for visualizing business functions and/or operations using at least one visual representation of the energy and information systems that comprise a business. More particularly, the present invention provides systems and methods for providing an automated system for identifying areas of a business for implementing changes in processes, human resources, metrics, and systems, wherein the identification is provided based upon generating a visual representation of a business based on the energy and information systems of the business, and by making those changes to improve the operating efficiency of the business.

A first aspect of the present invention is to provide methods for providing diagrammatic representations of the functions and/or operations of a business wherein the energy and information systems are represented by mechanical components that are interactive and proportionally or scalably consistent with the corresponding business components, functions, and/or people that together comprise the business, and further providing static and dynamic diagrams that illustrate these components changing over time to indicate areas of opportunity for improving the operational efficiency of a business using visual representations of the energy and information systems that comprise the business.

A second aspect of the present invention is to provide an automated system for identifying areas of a business for implementing changes in processes, human resources, metrics, and systems, wherein the identification is provided based upon generating a visual representation of a business based on the energy and information systems of the business, wherein the visual representation includes at least one diagrammatic representation of the business components, functions, and/or people that together comprise the business, and wherein the at least one diagrammatic representation of the business components, functions, and/or human resource elements provides relationally scaled diagram elements for each of them, and wherein the relationally scaled diagram elements are relationally scaled based upon the financial information and data inputs corresponding to each of them. Such system for providing visual representation of energy and information systems for a business and its operating efficiency includes a data set stored on a computer, the computer further comprising a memory, a processor, and a display that are functionally interactive, the data set including data relating to business operations; a visual representation of the data set including at least one diagram shown on a graphic user interface of the display, wherein the at least one diagram including a mechanical device having elements that are arranged and configured to correspond to and to illustrate the movement of information and/or energy through the systems of the business. Also, preferably in the system embodiments, the at least one diagram and its elements are derived from and electronically linked to financial data included within the data set.

The present invention is further directed to a method for identifying areas of a business to change for improving the business operation and profit, the areas being identified by using a dynamic, visual representation of a business including at least one diagrammatic representation of the business components, functions, and/or human resource elements, that is generated based on the energy and information systems corresponding to them, and further providing steps for user interaction with the data inputs and/or the diagram for visualizing the impact of changing at least one of the diagram elements or its corresponding financial information or data inputs, updating the diagrams and optimizing the business systems thereby.

Thus, the present invention provides systems and methods for providing visual representation of the energy and information systems, in addition to human resource elements, including at least one diagrammatic representation for providing a scale and perspective on those systems and human resource elements, such that the business systems can be understood, modeled, modified based on data, projections, or based on experimentation, and then business decisions and actions can be made to make changes in any part of the systems for creating positive impact, i.e., to increase the profitability of the system therefrom, and then to produce a new visualization of the improved system to illustrate that positive impact. Preferably these systems and methods provide for static, dynamic, and interactive diagrams via graphic user interfaces on a computer display such that modifying the data or the diagrams correspondingly modifies the entire system and its components and supporting, electronically linked data.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a side view of a visual representation of the energy and information systems of a business (gears).

FIG. 2 is a bar graph illustrating time-based changes in a business based upon the revenue and expense data associated with the business, in accordance with an embodiment of the present invention.

FIG. 3 is a chart showing a detail report for business transactions within a business.

FIG. 4 is another bar graph illustrating time-based changes in a business based upon the revenue and expense data associated with the labor of that business, in accordance with an embodiment of the present invention.

FIG. 5 is a chart showing a detail report for business transactions for credit card activity within the business.

FIG. 6 illustrates a spreadsheet showing the relationships between the components of a business or business system.

FIG. 7 shows a spreadsheet having database indications and/or reports that are associated with human resource activities and daily operations checklists of activities.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides systems and methods for providing visual representation of the energy and information systems, in addition to human resource elements, that provide a scale and perspective such that the business systems can be represented diagrammatically, and based on those diagrams to be understood, so that business decisions and actions can be made to make changes in any part of the systems for creating positive impact, i.e., for increasing the profitability of the system. These systems and methods include providing an automated system for identifying areas of a business for implementing changes in processes, human resources, metrics, and systems, wherein the identification is provided based upon generating a visual representation of a business based on the energy and information systems of the business, and by making those changes to components that most significantly improve or positively impact the energy and information systems of the business to improve the operating efficiency of the business. By way of example and not limitation, these changes often include eliminating friction between people, job functions, departments, and any other human resource interaction.

In preferred embodiments of the present invention, systems and methods for providing visual representation of the energy and information systems, in addition to human resource elements, include at least one diagrammatic representation for providing a scale and perspective on those systems and human resource elements, such that the business systems can be understood, modeled, modified based on data, projections, or based on experimentation, and then business decisions and actions can be made to make changes in any part of the systems for creating positive impact, i.e., to increase the profitability of the system therefrom, and then to produce a new visualization of the improved system to illustrate that positive impact. Preferably these systems and methods provide for static, dynamic, and interactive diagrams via graphic user interfaces on a computer display such that modifying the data or the diagrams correspondingly modifies the entire system and its components and supporting, electronically linked data. Thus, the present invention further provides systems and methods that further provide a new or updated visualization of the improved system to illustrate the positive impact from changing the energy and information systems of the business.

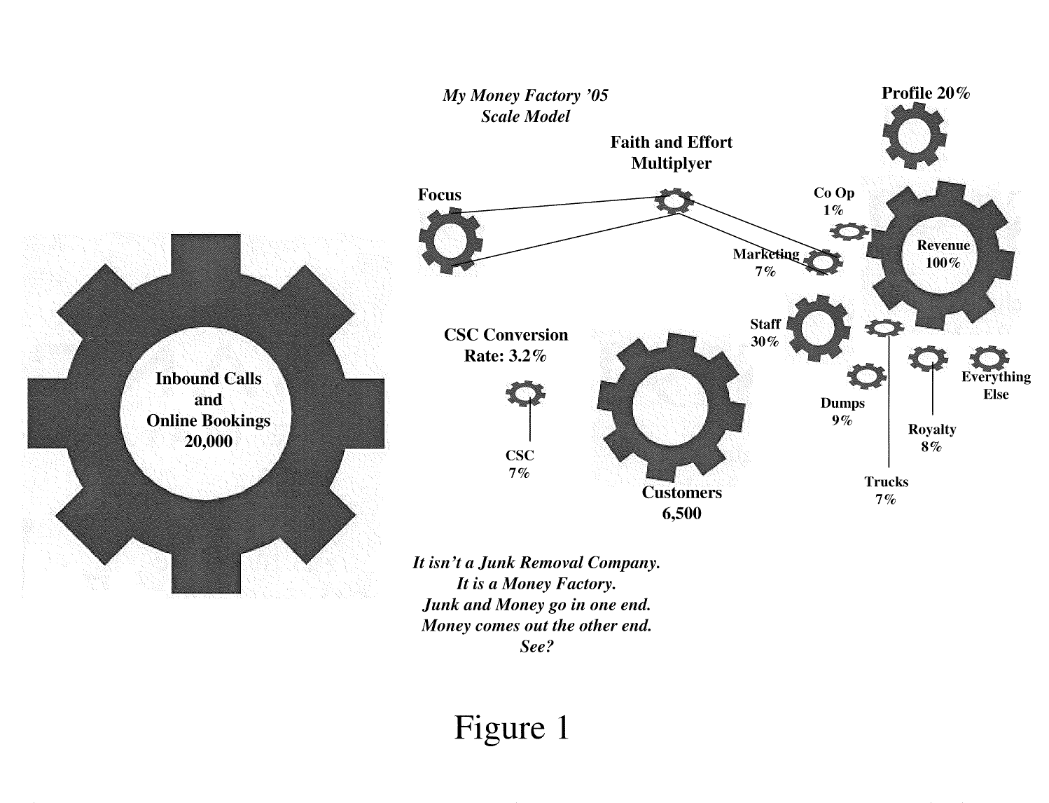

Referring now to the drawings in general, the illustrations are for the purpose of describing a preferred embodiment of the invention and are not intended to limit the invention thereto. As best seen in FIG. 1, a side view of a static visual representation of the energy and information systems of a business is provided with at least one diagram wherein the energy and information systems are visually represented on a graphic user interface viewable by a user, the at least one diagram including a series of interactive gears, the rotational movement of which illustrates the movement of information through the systems of the business, which also corresponds to the movement of money or energy through the business. In this illustration, the movement is generally flowing from left to right with the functional and interactive arrangement of the at least one diagram component (here a multiplicity of interconnected rotatable gear elements) to provide additionally for a second dimension or vertical movement (up and down) at various positions from the starting (left) side where information and inputs originate in the overall business system and there between through to the ending (right) side where profit is output at the end or completion of a business cycle. The rotation of the gears is selectively identified by the unit of measure corresponding to that business component, wherein each business component is associated with its own gear. By way of example and not limitation, gear rotation may be identified with units of: the number of calls per unit of time (hour, week, month, etc.) for a business component that is predominantly based upon a call center that is making or receiving calls, making online bookings, etc.; or the number of customers per unit of time (hour, week, month, etc.) for a business component that conducts sales or converts sales leads to actual sales or contracts. A functional model or visual representation of a business illustrates how all of the major components of the business interact with each other. FIG. 1 shows a static image (which may also be represented by a screenshot of a graphic user interface generated by a computer and shown on a display) for a junk removal business, wherein the gears represent components of the business and are made to scale, wherein the scale is based upon a breakdown of the components in the income statement for the business and the sales funnel, and the components interact functionally as a series of interactive gears. The model depicted in FIG. 1 emphasizes only major business components and business departments, and does not include job functions and people; however, the components of job functions and people are preferably included in a visual representation of a business, where the complete business picture is required, since job functions and people are often sources of friction and also relate to reporting pathways in a business, which relate and correspond to the movement of information through a business.

In a preferred embodiment, the systems of the present invention provide for automatic generation of the at least one diagram, preferably including a machine-based visual representation of the energy and information systems of a business in a graphic user interface form, the system comprising a computer having a memory, processor, power supply and all components known to one of ordinary skill in the art for providing a functional computer device, and further including a display for showing a graphic user interface to a user, wherein the visualization is dynamic, or functional to show movement of the business components with respect to each other as the business operation is represented thereby. In the case of the business visual representation by gear elements or components in FIG. 1, the gears representing business components rotate at predetermined rates based upon the units corresponding to that business component, as set forth in the foregoing. Additionally, alignment or misalignment of the business components is further represented visually, in particular for a dynamic representation of the business, by an unstable rotation or wobble, the degree or amount of vibration being indicative and corresponding to the degree to which that business component is out of alignment with the rest of the system. Also, friction between business components is represented visually, using color-based indicators, such as red wherein the intensity of the color-based indicator or the actual color selection itself further provides a visual representation or indication that corresponds to the degree to which friction exists between components of a business. As with a machine, mis-alignment and friction negatively impact the efficiency of the business, and negatively affects the movement or progression of energy and information through the business systems and processes.

In the visualization of a business represented in FIG. 1, money and mass are units of scale that are represented by the business components as well, wherein the diameter of the gears corresponds to the financial size of the business component, which also relates to its mass, once again representing the business visually by images associated with mechanical or machine-based representation.

In preferred embodiments of the present invention, the data relating to the business operation is the source of the visual representations of the business, specifically revenue and expenses data; as such, rather than merely providing a single snapshot view of the business, it is preferred that the data from the business operation be considered over time, since time provides another dimension and therefore provides more information about the business. Preferably, the data is updated daily for the business. However, a consistent or regular update on a reasonable rate for a given business appropriate to indicate cycles, such as seasonality or other cycle of the business.

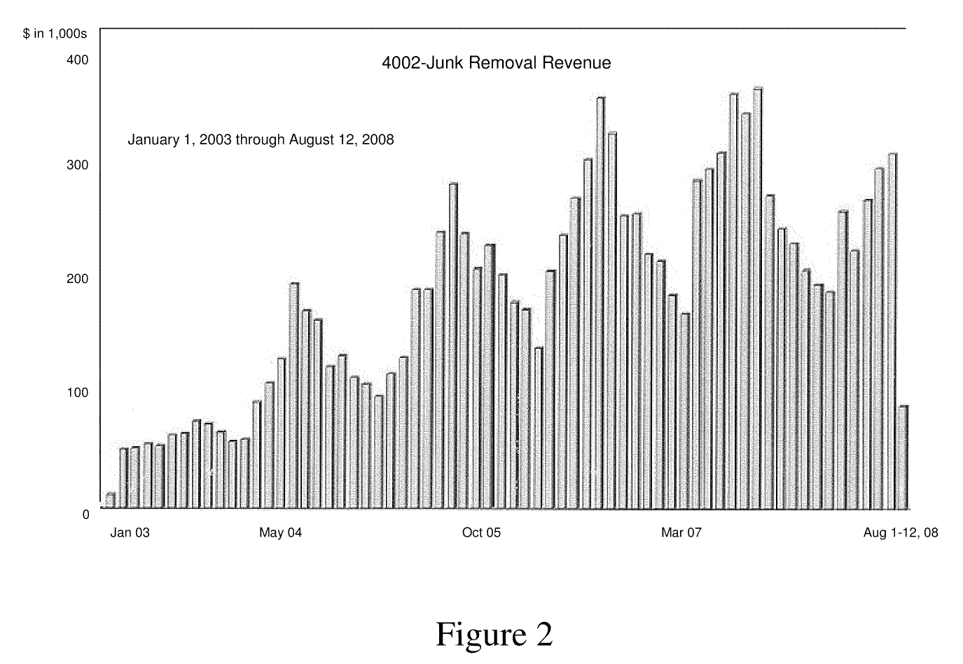

FIG. 2 is a bar graph illustrating time-based changes in a business based upon the revenue and expense data associated with the business, in accordance with an embodiment of the present invention. Preferably, the data for the bar graph of FIG. 2 is updated automatically on a predetermined time basis, such as daily, or on whatever basis is appropriate for a given business and its corresponding cycles. By way of example for the purposes of illustrating the present invention and not limiting it thereto, consider that the bars on the bar chart of FIG. 2 relate to monthly revenue for a business. Furthermore, correlating these bars to the diameter of the gears (and correspondingly to the size of the business components they represent) and modifying the visual representation of FIG. 1 accordingly provides a dynamic or changing visual representation of the business based upon which month that visual representation of the business is generated. Thus, over time, the visual representation of the business includes larger or smaller components, based upon the financials data for the business that changes (in this example, it changes monthly, illustrating how the business is growing or shrinking over time in response to changes in revenue and expenses). In FIG. 1, there are some gears that represent variable information, and are therefore variable in diameter over time. In the example illustrated in FIG. 2, the gears that represent business components that have variable financial-related information will change diameter monthly as that corresponding financial data changes monthly. The fixed cost gears do not vary in diameter over time. This results in a dynamic version of the business represented visually as in FIG. 1 wherein the systems of the business are affected by changing gear ratios over time, i.e., the business components and the way they relate to each other and interact with each other correspondingly changes over time as with the gear ratios. Importantly, it is this visualization, especially the dynamic visual representation of a business and its corresponding components and how they interact and relate to each other over time, that provides meaningful information through this visual format, creating a perspective about how the business is functioning, including where and what components of the business, and how to improve the efficiency of the business by understanding the function and interaction and relationship of the components of the business over time. Nowhere does the prior art teach, disclose, or provide methods and systems for providing visual representation of a business that includes the components, functionality, and perspective provided by the present invention.

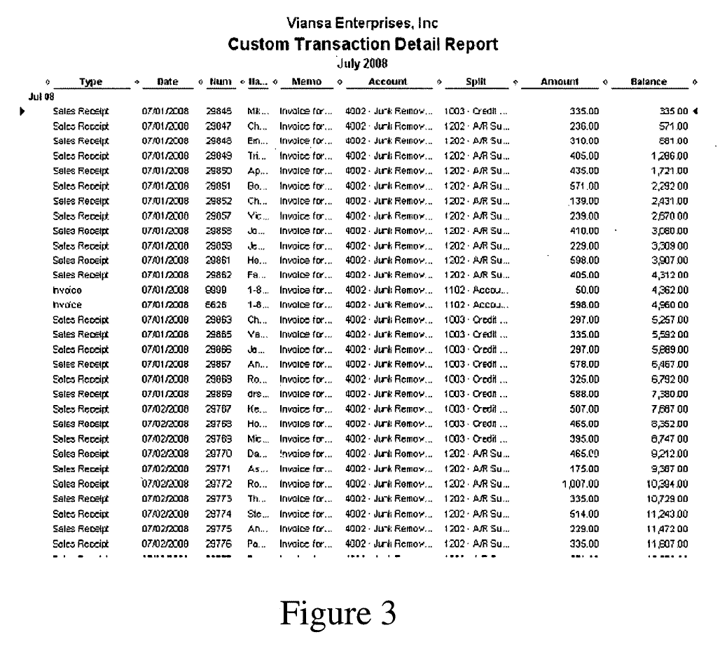

FIG. 3 is a chart showing a detail report for business transactions within a business. As shown in the chart of FIG. 3, which includes a plurality of rows or line items associated with a given day; multiple days are shown. Each day includes a multiplicity of discrete jobs that introduce money into the business system. Each month is therefore a collection of days and the jobs associated with each day. Extending the present invention, each month, therefore, includes money produced by the number of job-days multiplied by the revenue per job-day in that month. In a business system, the operational gear comprises money that indicates the total “mass” of the component. Accordingly, as provided by the present invention, a visual representation of the business using gears as in FIG. 1 would include the type of information in FIG. 3 by representing it for the mass of the gears, using money as the unit of scale. Preferably, all financial data for revenue and expenses are automatically included in the visual representation of the business according to the present invention.

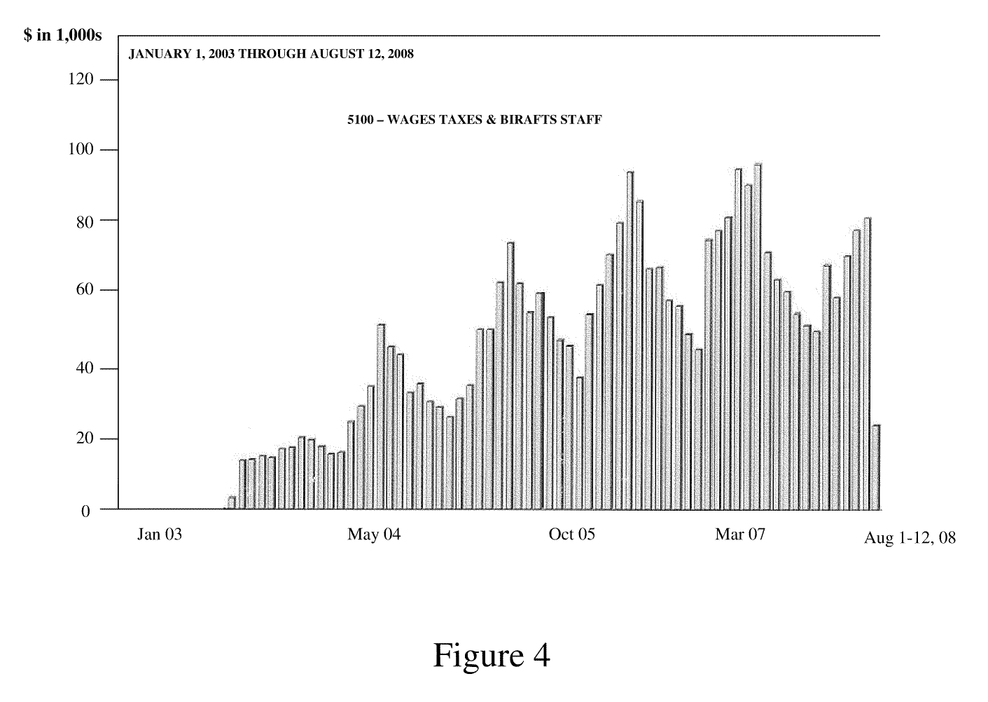

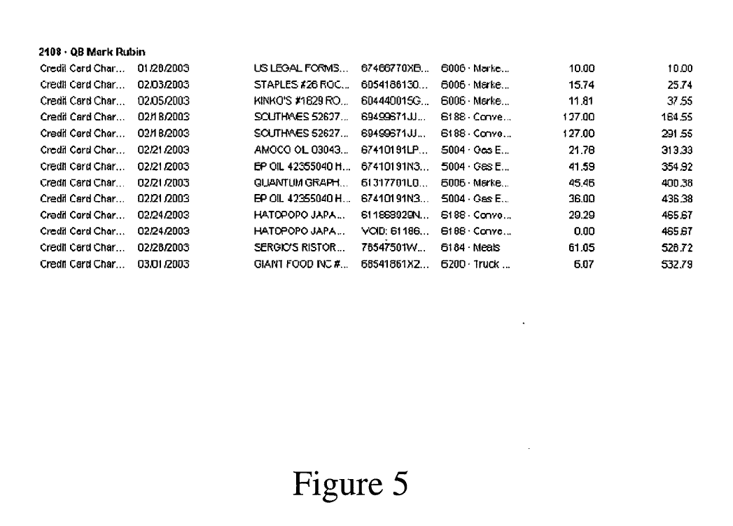

FIG. 4 is another bar graph illustrating time-based changes in a business based upon the revenue and expense data associated with the labor of that business, in accordance with an embodiment of the present invention. Each of the monthly bars is preferably modeled as a gear following the visualization systems and methods that are illustrated in FIG. 1 (for different data). Similarly, FIG. 5 is a chart showing a detail report for business transactions for credit card activity within a business. All of the revenue and expense components are preferably automatically categorized into their relevant and corresponding income statement components. For a complete visual representation of a business using the systems and methods of the present invention, it is preferred to track and include every single discrete input and output of the target business or business system; these provide the data relating to units of money that are mapped or translated into visual representations of the business and its components by corresponding machine components (as in the interactive gears of FIG. 1). Then, on a predetermined time basis that is appropriate for the business, such as monthly, the business is modeled or represented by gears having variable diameters, wherein the sizes of the gears are directly proportional to the percent of revenue of each of the expense components.

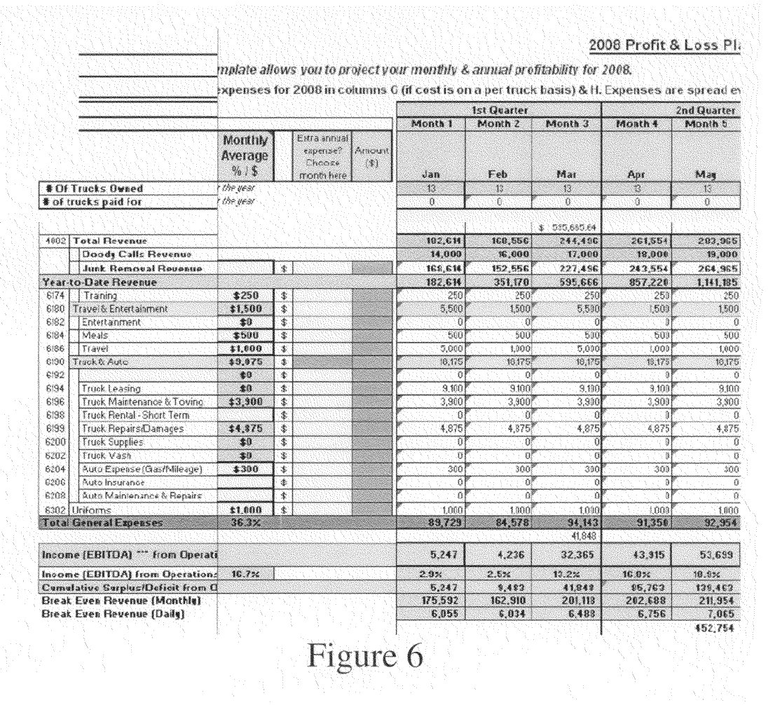

FIG. 6 illustrates a spreadsheet showing the relationships between the components of a business or business system. These are functional relationships and include the ratios between those functions, and projected seasonal factors based on historical data, if any, and as appropriate. Next, the methods of the present invention provide for automating the movement of information through the business by matching the sampling frequency and the units of work against compensation plans for people doing the work. Compensation plans impact the performance of the people in various departments, jobs, functions, activities, and roles in a business. Thus, by connecting the compensation plans to the efficiency of the business based on the contributions of the person(s), their behavior will be modified to positively impact their compensation, and correspondingly to positively impact the efficiency and profitability of the business.

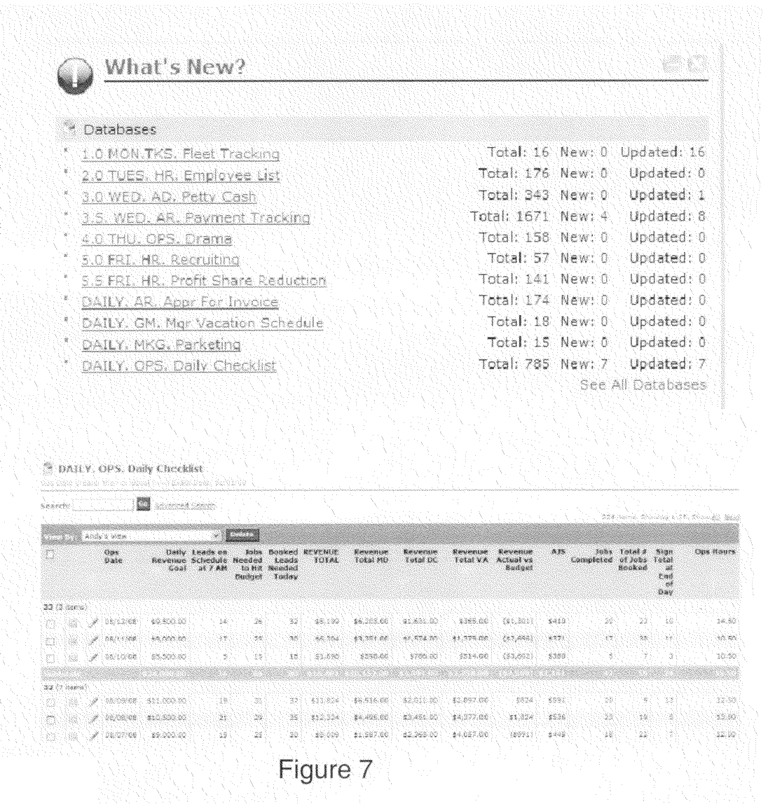

FIG. 7 illustrates a screen shot of a graphic user interface on a display showing job functions and people associated with a calendared timing for the related movement of information within the business. It is important to establish a regular rhythm for the people performing the work that makes up the business in order to ensure that the cycles of the business run smoothly, without misalignment or friction. Furthermore aligning the compensation plans with the work that makes up the business creates ownership and accountability of the individual tasks that make up the work, as in FIG. 7.

The systems and methods of the present invention preferably provide visual representation of the time, energy, information, and money associated with the operation of a business. method for providing visual representation of the energy and information systems for a business and its operating efficiency including the steps of: providing a data set stored on a computer, the computer further comprising a memory, a processor, and a display that are functionally interactive, the data set including data relating to business operations; processing the data set to convert it to a visual representation of a mechanical device further including a series of elements that are configured to correspond to and to illustrate the movement of information through the systems of the business, and which also correspond to and illustrate the movement of money or energy through the business. More particularly, the series of elements includes a series of interactive rotational elements, wherein the rotational movement of these elements illustrates the movement of information through the systems of the business, and preferably further illustrates the velocity or acceleration of the elements at that point in the system. That is, the mechanical gears represent the “scale” of the thing they are measuring as it relates to the whole system, and the velocity of the information (or acceleration if the velocity is changing). Also, the data set is linked to the visual representation of the mechanical device. Furthermore, the data relating to business operations include revenue and expense data and preferably include a series of data relating to business operations over time.

According to the present invention, the methods and systems for providing an automated system for identifying areas of a business for implementing changes in processes, human resources, metrics, and systems includes steps for determining how things are changed, including identification and generation of suggested areas for change that are based on an understanding of three things that are interrelated and that are visually represented by the area of a triangle that has three legs that represent a time (in days), energy (based on a scale that is related to the money), and money (in dollars).

For example, if opportunity A is going to take 10 days, cost 10 dollars, and is very difficult (energy=10 units), the area of that triangle would be big. If opportunity B is going to take 10 days, cost 10 dollars, and is very simple (energy=1 unit), the area of that triangle would be small. In this example case, opportunity B is the better choice. In application within the systems and methods of the present invention, every place that is represented within the visual representation of the business including the diagrammatic representation of the business elements also provides for a visual representation of friction between those elements (in the example embodiment wherein the diagrammatic representation includes a machine with gears, the friction is visually represented at those points where the gears touch each other), there would be an opportunity created and defined, and automatically identified by the system as an area of the business that may be changed to be improved, if friction is present there. The details of the opportunity for improvement are preferably defined by factors that are input by a user, preferably a person who is familiar with the interface of those business elements that are touching to create the friction. Friction is generated or exists when information is exchanged or moved through the business, so the people, job functions, and departments on both sides of the exchange need to define exactly what information they need to move, create the reports in the system, and use those reports to manage what is happening in the system. If these are not defined, then friction at those intersections exists; the system identifies those areas of the business as needing to be changed to improve the efficiency and profitability of the business.

There are two ways to use the diagrammatic models of the present invention to visually represent what needs to be changed. First, it is important that the “gears” that touch each other spin at the same speeds. For example, if the Sales Department sells 100 jobs that cost 5 man hours each, the HR Department would need to hire 500 man hours of people. The system would know the sales funnel and time frames, and it would also know the hr funnel and time frames. Given this, the HR department would be able to “see” the sales funnel gear spinning faster, and this would create friction (in red) where they touched. When the HR department ramped up, their gear would be spinning at the same speed to deliver 500 man hours to the system. Second, there are four areas “friction” that need to be addressed. All of these things can be measured with surveys and performance reports that are setup and established by managers.

Friction between Departments and Departments: This generally happens because of missing reports. See the example above. This is easy to measure by talking about the interfaces between departments. It is also easy to fix because the opportunities are easy to see and define. Most of the time, it is related to timing errors.

Friction between Departments and Job Functions. This generally happens because of missing reports and poor hires. This goes back to HR errors and poor job definitions. This “friction” would create opportunity to create better job definitions, and use those definitions to hire better people. These two opportunities would be defined in the system and sorted by the area of the time, energy, and money triangle.

Friction between Job Functions and People. This happens when people can't or wont' do their job. Basic employee surveys and performance evaluations can be used to capture and measure this data. When it is completed for an individual department, the same time, energy, and money approach can be used to put systems in place to either improve performance (by training) or replacing people.

Friction between People and People. This happens when people don't like each other. This is definitely not my area of expertise, but surveys can be used to obtain this info and it can be visualized on the gears and on the information map.

One thing to point out is the importance of the information map, which is another visual representation and diagram of the present invention. This shows a measurement the “friction” at each point in the system, which again is indicated on the mechanical diagram as in FIG. 1, where the gears are approximately touching (the contact points are not illustrated to facilitate the illustration of the “gears” being independent; however, it is intended that at those tangential points most proximal to other gears, there would be direct contact there). By clicking on the information map or the diagram of the business as in FIG. 1, the user will be able to see the friction and opportunities for improvement. In other words, the information map (the nodes) is the place where the reports and information live. Thus, the gears in the mechanical diagram of FIG. 1 measure the energy (and include a visualization and indications of the friction and opportunities for change in the business to reduce or eliminate that friction thereby increasing the efficiency and profitability of the business) and the distance between the nodes represents the information (and the measurement of the friction) at that point.

In preferred embodiments of the methods of the present invention, a method is provided including the steps of: providing a data set stored on a computer, the computer further comprising a memory, a processor, and a display that are functionally interactive, the data set including data relating to business operations; processing the data set to convert it to a visual representation including at least one diagram viewable on a graphic user interface of the display, wherein the at least one diagram including a mechanical device has elements that are arranged and configured to correspond to and to illustrate the movement of information and/or energy through the systems of the business, and which are derived from and electronically linked to financial data associated with the business; identifying areas of the business operations for making changes thereto for improving business operations efficiency and profitability; automatically associating the areas of the business operations for making changes thereto with corresponding elements of the at least one diagram; and representing the changes on at least one second set of diagrams.

In preferred embodiments of the systems of the present invention, a system for providing visual representation of energy and information systems for a business and its operating efficiency is provided including: a data set stored on a computer, the computer further comprising a memory, a processor, and a display that are functionally interactive, the data set including data relating to business operations; a visual representation of the data set including at least one diagram shown on a graphic user interface of the display, wherein the at least one diagram including a mechanical device having elements that are arranged and configured to correspond to and to illustrate the movement of information and/or energy through the systems of the business. Also, preferably in the system embodiments, the at least one diagram and its elements are derived from and electronically linked to financial data included within the data set.

Alternatively, the data set may be stored on a remote server computer that is constructed and configured and operable to be accessed by a computer device having a display, wherein the visual representation of the business including the at least one diagram is displayed on a graphic user interface of the computer device display for a user to review, wherein the computer device is in wired or wireless communication with the remote server computer for accessing the data remotely. By way of example and not limitation a “smart” mobile phone device having the same or similar functionality as a computer and a display operable for showing the visual representation, wherein the device accesses the data on the remoter server computer via wireless network such as wireless internet access to access the data and diagrams via a web portal. Secure access and authentication may further provide restricted access to the business data and diagrams to ensure that only predetermined users have access to the data, information, and diagrams provided by the system according to the present invention. This alternative system configuration and components are enabled through relevant documentation known in the art that provides for web-access, authentication, mobile computer networks, etc. that is not expressly set forth as one of ordinary skill in the relevant art will appreciate and understand.

Significantly, the present invention provides for interconnected diagrams, preferably electronically linked to provide a multiplicity of diverse representations of the underlying data associated with the energy and information systems of a business. By way of example and not limitation, the graphic user interface of a display to a user provides for view options so that the user can selectively (or the system is operable to automatically) display the different view options that interconnect the tables, graphs, and mechanical representations of the business information and energy systems (e.g., the figures set forth and described hereinabove being electronically linked and alternatingly or selectively groupedly viewable by the user, depending upon which views best represent the information and energy systems components, functions, and/or human resource elements, and combinations thereof that need to be reviewed and understood, and likely modified for optimizing the business (and therefore the profitability and/or revenue or other targets)).

Certain modifications and improvements will occur to those skilled in the art upon a reading of the foregoing description. By way of example, visual representation of the “sound” of the business may also provide indication of how the business is functioning, in particular for identifying areas of misalignment and friction. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A method for providing visual representation of the energy and information systems for a business and its operating efficiency comprising the steps of:
providing a data set stored on a computer, the computer further comprising a memory, a processor, and a display that are functionally interactive, the data set including data relating to business operations;
processing the data set to convert it to a visual representation including at least one diagram viewable on a graphic user interface of the display, wherein the at least one diagram including a mechanical device has elements that are arranged and configured to correspond to and to illustrate the movement of information and/or energy through the systems of the business, and which are derived from and electronically linked to financial data associated with the business;
identifying areas of the business operations for making changes thereto for improving business operations efficiency and profitability;
automatically associating the areas of the business operations for making changes thereto with corresponding elements of the at least one diagram; and
representing the changes on at least one second set of diagrams.

2. The method of claim 1, wherein the elements includes a series of interactive elements, wherein the interaction of these elements illustrates how information is transferred through the systems of the business.

3. The method of claim 1, wherein the elements includes a series of interactive rotational elements, wherein the rotational movement of these elements illustrates the movement of information through the systems of the business.

4. The method of claim 1, wherein the rotational movement of the elements further illustrates the velocity or acceleration of the elements at that point in the system.

5. The method of claim 1, wherein the data set is linked to the visual representation of the mechanical device.

6. The method of claim 1, wherein the data relating to business operations include revenue and expense data.

7. The method of claim 1, wherein the data relating to business operations include a series of data relating to business operations over time.

8. The method of claim 1, further including the step of presenting the visual representation in a dynamic format.

9. The method of claim 8, wherein the dynamic format visually illustrates changes over time.

10. A system for providing visual representation of energy and information systems for a business and its operating efficiency comprising:
a data set stored on a computer, the computer further comprising a memory, a processor, and a display that are functionally interactive, the data set including data relating to business operations;
a first visual representation of the data set including at least one diagram shown on a graphic user interface of the display, wherein the at least one diagram including a mechanical device having elements that are arranged and configured to correspond to and to illustrate the movement of information and/or energy through the systems of the business, and
a second visual representation of the data set including the at least one diagrams from the first visual representation showing modifications thereto, wherein the modifications illustrate changes made based upon identifications of areas needing change to optimize the business operations.

11. The system of claim 10, wherein the at least one diagram and its elements are derived from and electronically linked to financial data associated with the business.

12. The system of claim 10, wherein the at least one diagram and its elements are derived from and electronically linked to financial data included within the data set.
